(19) United States
(12) Patent Application Publication
(10) Pub. No.: US 2011/0162533 A1
(43) Pub. Date: Jul. 7, 2011

(54) Coffee Holding Arm of a Coffee Machine with Hand Loading

(75) Inventor: Stefano Fumagalli, Milano (IT)

(73) Assignee: GIRMI S.P.A., Omegna, Verbania (IT)

(21) Appl. No.: 13/061,899

(22) PCT Filed: Sep. 1, 2009
(86) PCT No.: PCT/IB09/53804

§ 371 Date: Mar. 2, 2011

(30) Foreign Application Priority Data
Sep. 2, 2008 (IT) BS2008A000164

(51) Int. Cl. A47J 31/44

(52) U.S. Cl. 99/295

(57) ABSTRACT

A coffee holding arm of a hand loading electric machine for making coffee, comprising a lever (12), a container (14) for a sealed capsule (30), a perforation device comprising a base body (360) which, thrust towards the container, causes perforation of the capsule. Means of extraction are envisaged for thrusting the capsule out of the container to facilitate extraction of the used capsule when the arm is separated from the machine after use.

This invention concerns a hand loading coffee machine and in particular a coffee holding arm that can be engaged manually with the machine body.

Currently well known hand loading coffee machines comprise a machine body which houses a cold water tank, an electric boiler and a device for delivering boiling water.

The machine body has an outlet opening which can be engaged manually by an arm with a lever and with a container for ground coffee. The container has a perforated bottom for delivery of the beverage into a cup, glass or similar.

The loose ground coffee may be spooned into the container; alternatively the ground coffee is contained in a monodose sheath in permeable paper.

Having placed the ground coffee in the container, the arm is held by the lever and offered up manually to the to the machine body outlet opening, which it engages mechanically, usually by turning the arm manually around a vertical axis.

There is also another typology of electric machine known as “semiautomatic” and mainly found in workplaces. In this case the monodose capsule, in plastic or aluminium material, is inserted into a housing in the machine body.

Airtight capsules, usually in aluminium, ensure the best conditions of preservation for the ground coffee, maintaining taste and aroma unaltered since there is no interaction with the surrounding atmosphere.

Plastic capsules are not airtight inasmuch as the cap and bottom are already perforated.

However the airtight capsule cannot be used with hand loading machines since the capsule is completely sealed so the boiling water would not reach the ground coffee it contains.

The purpose of this invention is to create a hand loading electric coffee machine, and in particular an arm for the said machine, which is suitable for producing the beverage even with sealed capsules.

This purpose is achieved by an arm created according to claim 1 and by a machine created according to claim 11. The dependent claims describe variants of embodiment.

The characteristics and advantages of the arm and the machine according to this invention will be evident from the following description, given by way of example and not limitative, according to the attached figures in which:

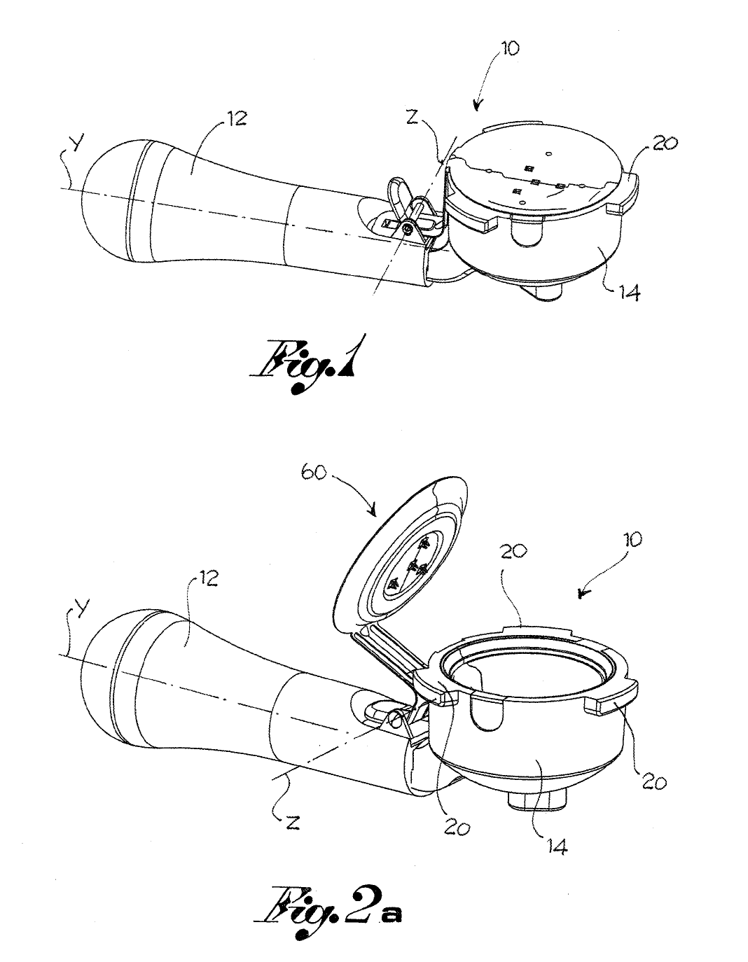

FIG. 1 is a perspective view of an arm for an electric coffee machine, according to one form of embodiment of this invention, in a closed configuration;

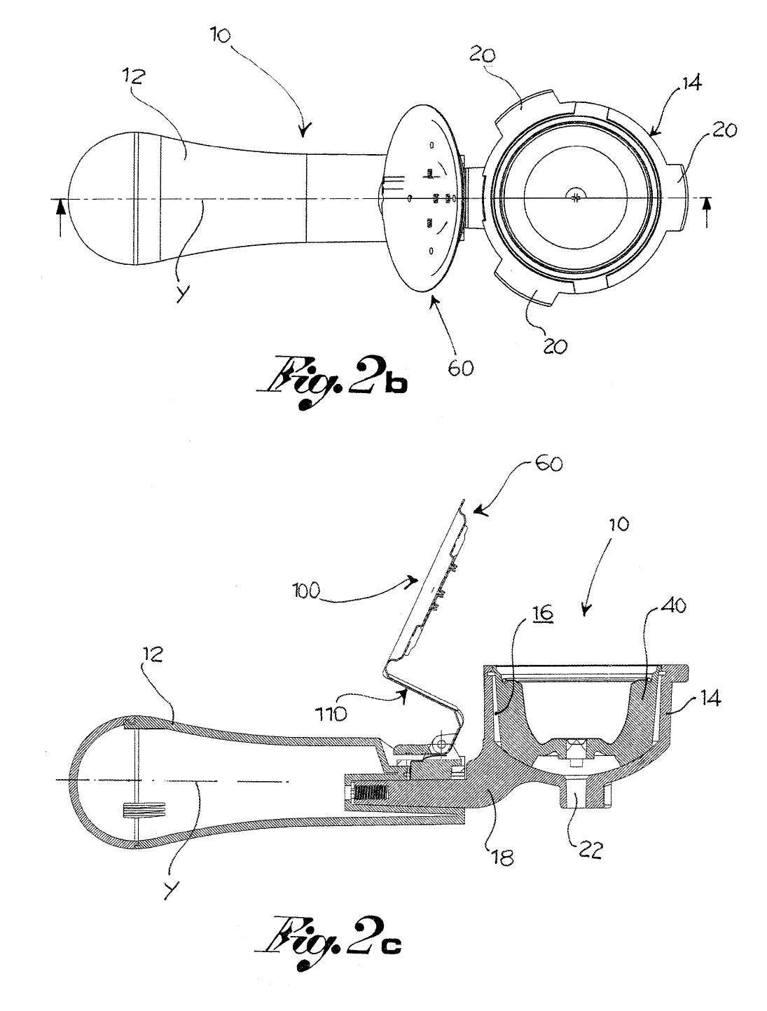

FIG. 2a illustrates the arm of FIG. 1 in an open configuration;

FIGS. 2b and 2c show respectively a plan and section view of the arm in FIG. 2a;

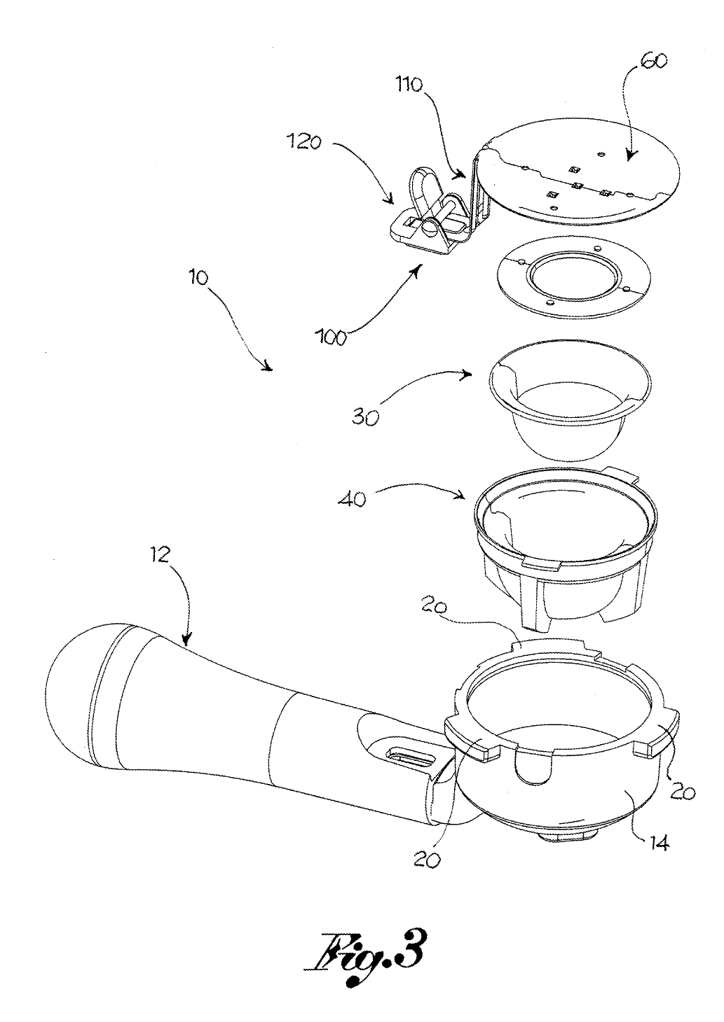

FIG. 3 represents a perspective separate part view of the arm according to this invention;

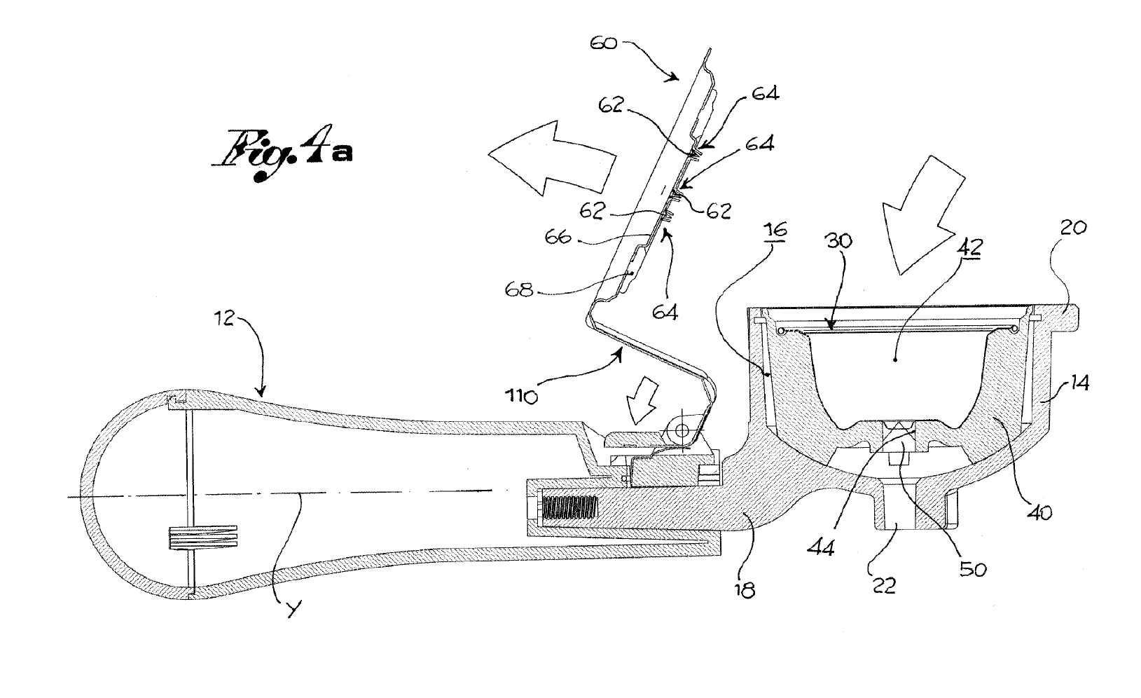

FIGS. 4a, 4b and 4c represent a sequence of engagement of the arm with sealed capsule and a machine body of the machine;

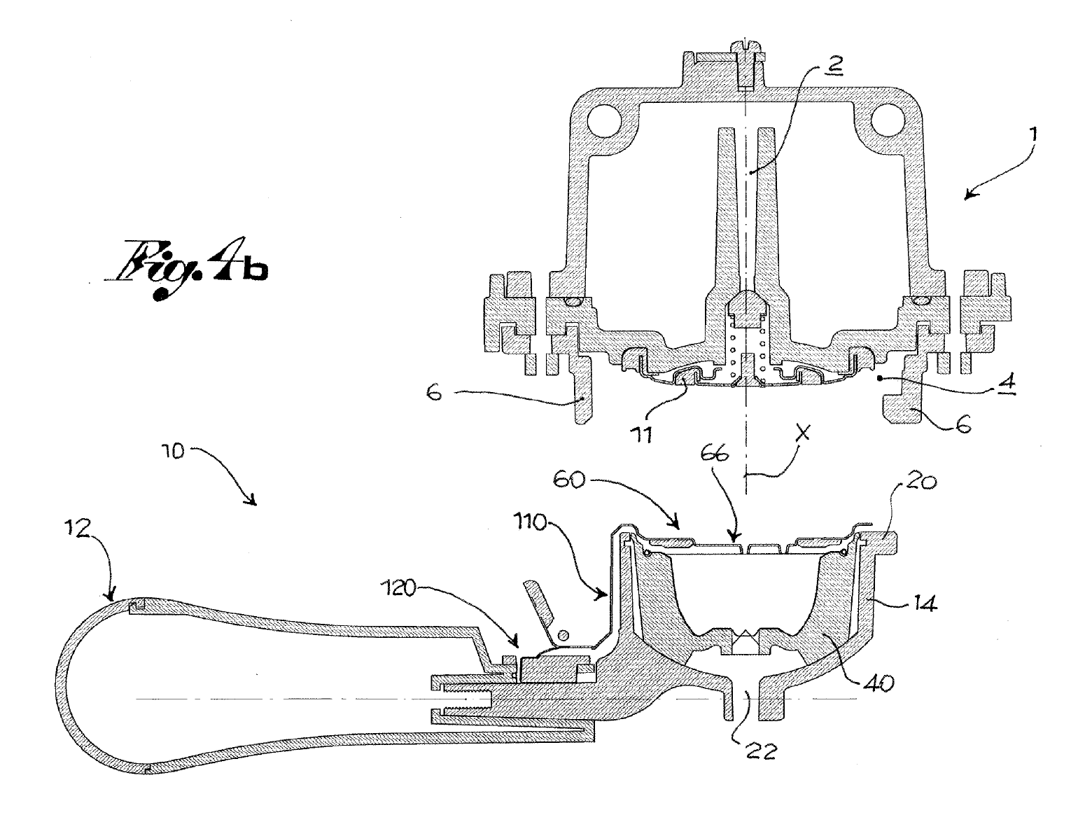

FIGS. 5a and 5b illustrate an enlargement of the engagement zone between the arm and the machine body in the course of the engagement sequence;

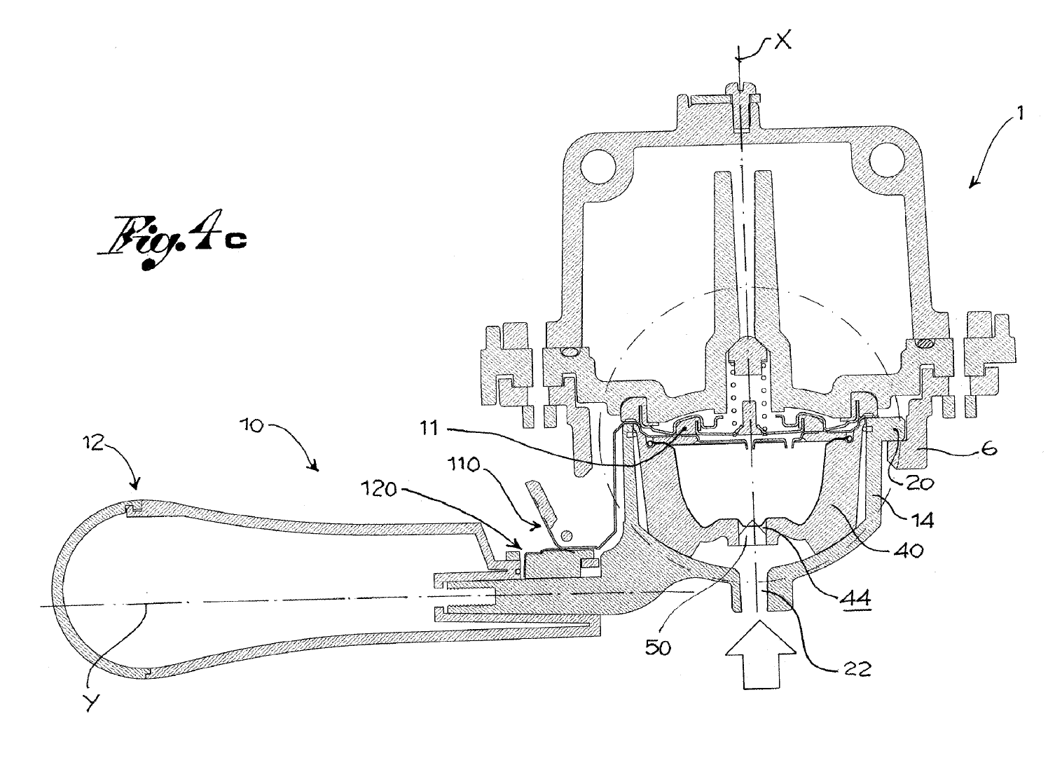

FIGS. 6a and 6b show respectively a perspective view and a section view of the arm connection device according to this invention;

FIGS. 7a and 7b illustrate perspective views of a portion of the arm, respectively without and with the connection device of FIGS. 6a and 6b;

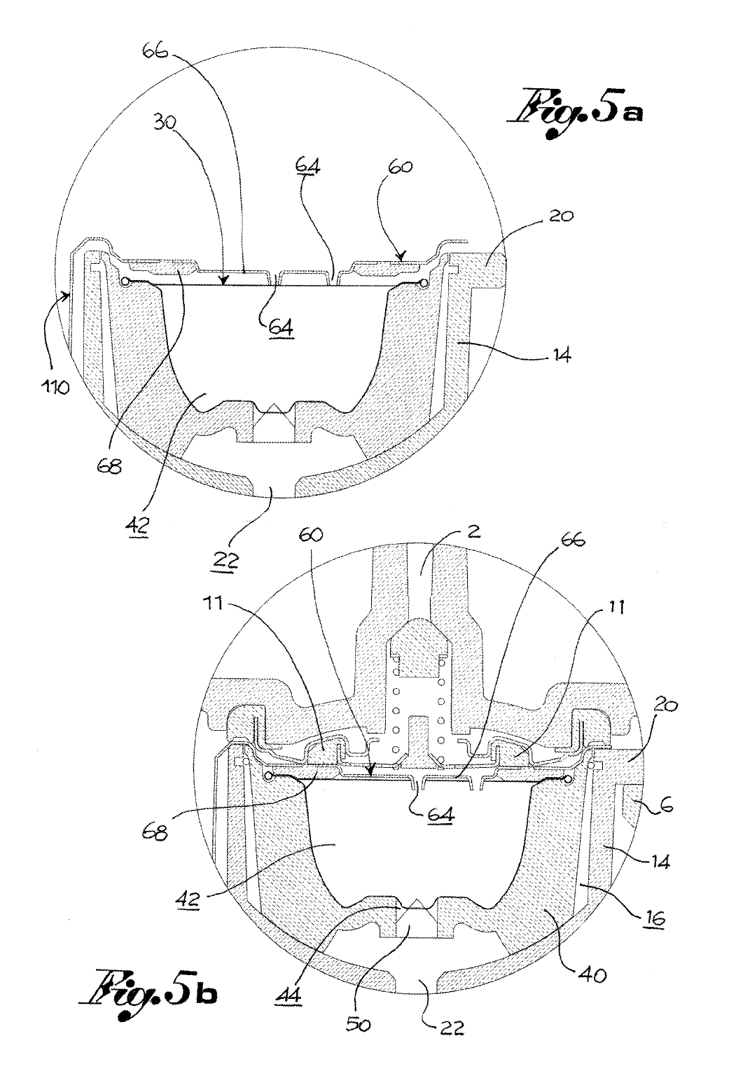

FIG. 8 shows an arm with non-sealed capsule engaged with the machine body;

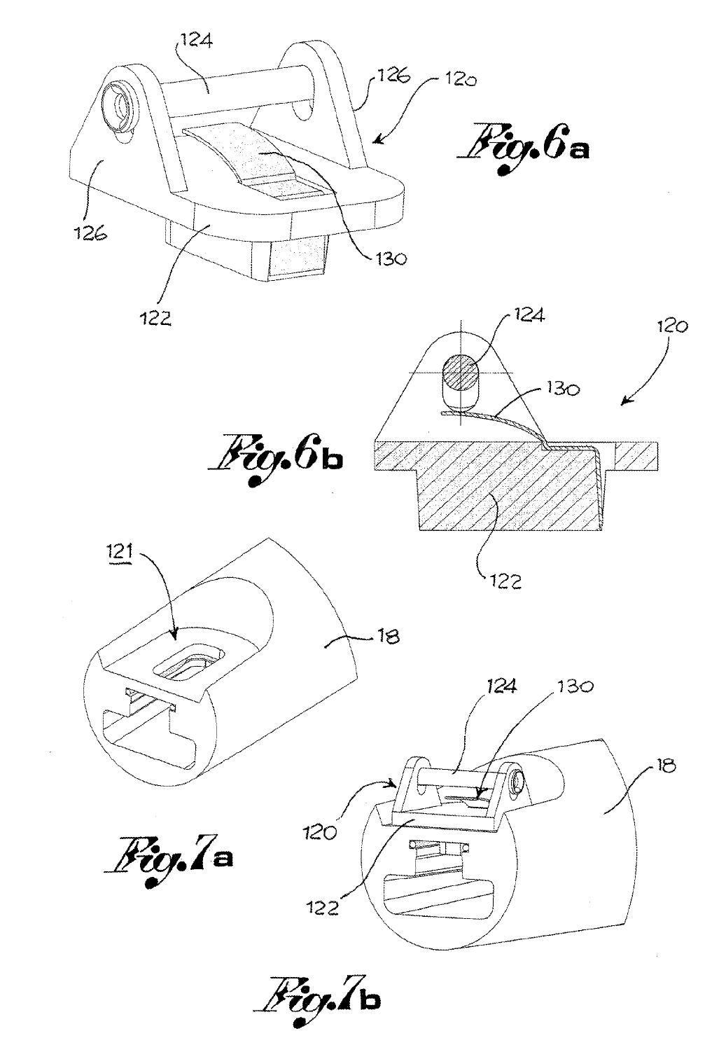

FIG. 9 illustrates a perspective view of an arm according to a further form of embodiment of this invention;

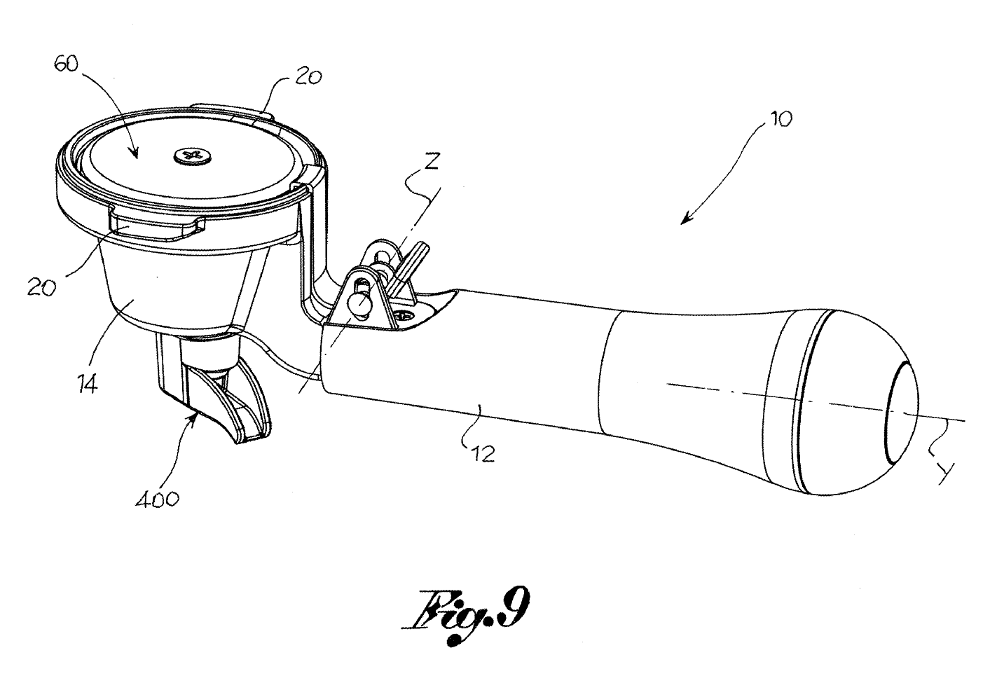

FIG. 10 shows a view in separate parts of the arm in FIG. 9;

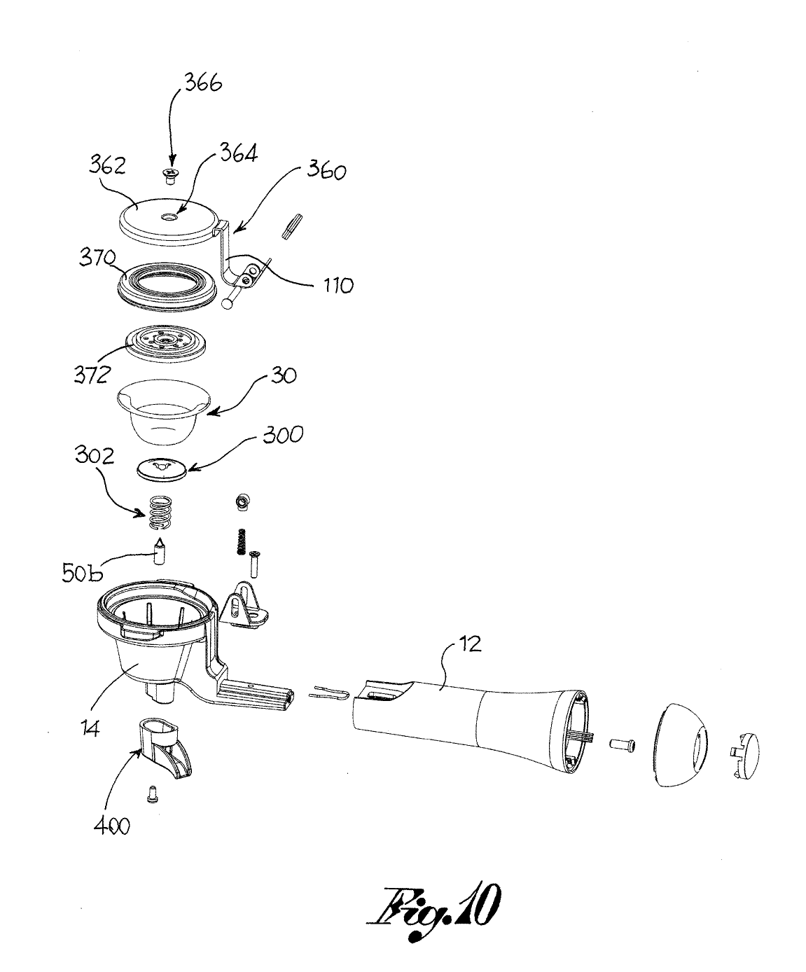

FIG. 11 represents a plan of the arm in FIG. 9;

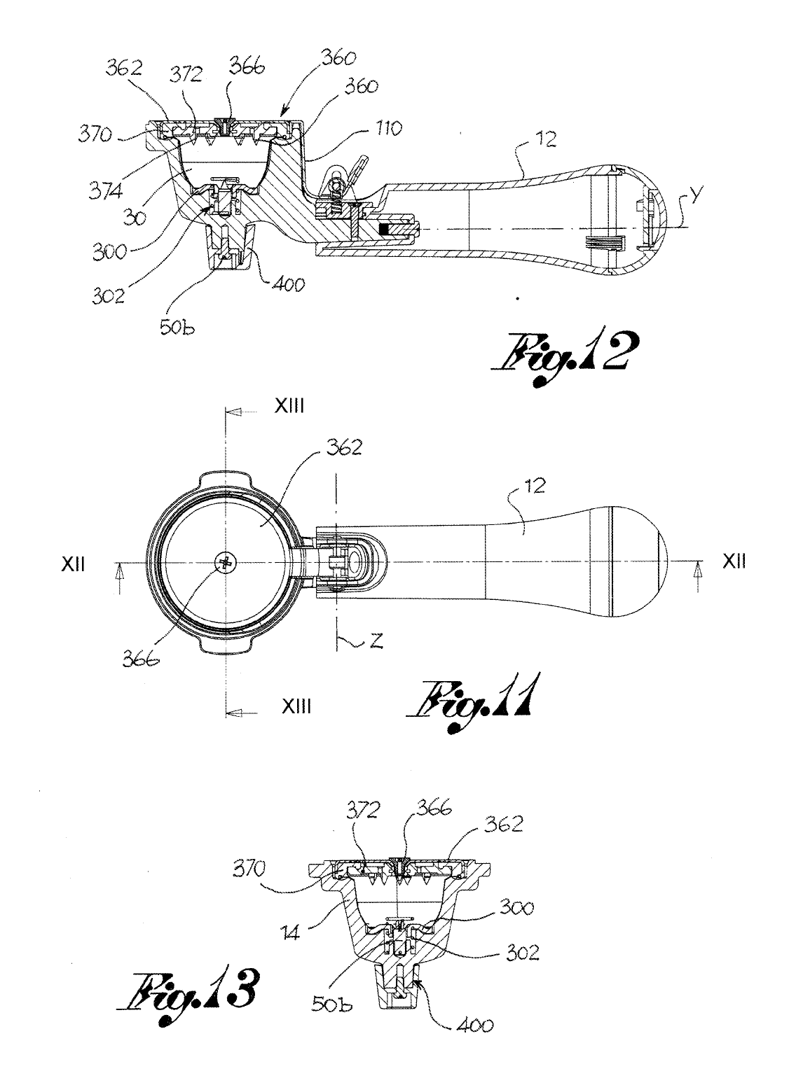

FIG. 12 illustrates a section view of the arm in FIG. 9, carried out according to section line XII-XII in FIG. 11; and

FIG. 13 illustrates a section view of the arm in FIG. 9, carried out according to section line XIII-XIII in FIG. 11.

The subject of this invention is a hand loading electric coffee machine comprising a machine body which houses a cold water tank, an electric boiler, a boiling water delivery device and means of controlling the delivery of boiling water.

The machine body comprises an outlet opening 1, operatively connected to the boiling water feed device.

For example, the outlet opening 1 comprises a boiling water feed conduit 2 which discharges into a collection chamber 4.

Collection chamber 4 is surrounded by an annular engagement wall 6, or stretches of wall set out annularly around an axis of outlet opening X, for mechanical engagement with coffee holding arm 10.

According to a favoured form of embodiment, the outlet opening 1 comprises a fixed detent, for example created by the said engagement wall 6 or by a detent element 11, for example ring type, within collection chamber 4.

In normal use of the machine, for example on a kitchen worktop, the axis of outlet opening X is vertical.

Arm 10 comprises a grip lever 12 which extends prevalently along lever axis Y, generally perpendicular to the axis of outlet opening X when the arm is engaged with the outlet opening.

Arm 10 also comprises a container 14, at an extremity of lever 12, whose container chamber 16 faces collection chamber 4 of the outlet opening 1 when the arm is engaged with the said outlet opening.

According to a favoured form of embodiment arm 1 comprises a stem 18, which is a single piece with container 14, inserted in lever 12 to make it an integral part of the latter.

Container 14 comprises at least several projecting fins 20, projecting radially from its edge, spaced angularly and suitable for creating a mechanical connection with annular wall 6 of outlet opening 1, for example a bayonet connection.

Container 14 is perforated on the bottom with for example at least one hole 22 for delivery of the beverage.

According to a favoured form of embodiment, arm 10 comprises an adapter 40 suitable for housing in container 14, with an internal adapter chamber 42 formed to receive sealed capsule 30, for example a capsule in thin aluminium containing ground coffee.

Adapter 40 is perforated on the bottom with adapter hole 44, creating a fluidic communication between adapter chamber 42 and container chamber 16, in particular with the beverage delivery hole 22.

Adapter 40 is preferably extractable from container 14.

Arm 10 moreover comprises means of perforation suitable for being activated by rotation of the arm engaged with outlet opening 1 to perforate the cap and bottom of capsule 30.

The means of perforation comprise at least one sharp element 50 set on the bottom of the adapter 40, for example at the opening of adapter hole 44, without blocking it.

Furthermore, the means of perforation comprise a perforation plate 60 suitable for placement on the container, surmounting capsule 30, equipped with pointed projections 62, the said projections being suitable for perforating capsule 30.

According to a favoured form of embodiment, plate 60 comprises a plurality of projecting conduits of plate 64 which link the part above the plate with the part below.

For example, each projection 62 is inserted in a respective conduit of plate 64.

Rotation of arm 10 engaged with outlet opening 1, and in particular the fins 20 with annular wall 6, guides the container in the direction of greatest penetration into collection chamber 4.

In particular, moving upwards the detent element 11 meets plate 60, crushing it in such a way as to push capsule 30.

The action of plate 60 against the capsule causes perforation of the bottom of the capsule by sharp elements 50 on the bottom of adapter 40, and perforation of the capsule cap by projections 62 of plate 60.

In this way, supplying boiling water through hot water feed conduit 2, it passes through plate 60 and the conduits of plate 64 into capsule 30 which contains ground coffee. The beverage thus infused passes out of the bottom of capsule 30 by way of the perforations effected by pointed elements 50 and, by way of the hole of adapter 44, to the bottom of container 14 and, by way of the hole of container 22, is delivered to the cup.

The means of perforation operate on the capsule simultaneously on rotation and shifting of the coffee holding arm containing the said capsule.

According to a favoured form of embodiment plate 60, at least with regard to the portion contained in the opening of adapter 40, when it is set on container 14, remains spaced from the edge of the said container or adapter in such a way as to create a suitable gap for crushing by detent element 11.

According to a favoured form of embodiment plate 60 comprises a central portion created by a shim 66, through which the conduits of plate 64 are realised, and an annular frame 68, set in such a way as to surround the central shim portion on the side facing the adapter chamber 42.

Preferably, when arm 10 is engaged with outlet opening 1 and plate 60 crushes capsule 30, frame 68 is in abutment with the edge of adapter 40, to crimp the edge of the capsule cap.

According to a favoured form of embodiment, arm 10 comprises a perforation device 100, comprising the said plate 60 and a foot 110 connected to plate 60, for example in an S-shape.

According to a favoured form of embodiment, foot 110 is made in a single piece with shim 66 of plate 60, for example by pressure die-casting.

At the other extremity foot 110 is hinged, for example to lever 12 or stem 18 of arm 10, in such a way as to permit rotation of plate 60 which in this way shifts from or overlays container 14.

In particular, foot 110 is hinged in such a way as to permit rotation around rotation axis Z, perpendicular to the axis of lever Y.

For example, arm 10 comprises a connector 120 that can be set in a housing of connector 121 in the lever or in foot 18 and is suitable for retaining perforation device 100 hinged by means of foot 110.

For example, connector 120 comprises a base 122 that can be inserted in the housing and a pin 124, fixed and set spaced from base 122, for example by side supports 126.

Moreover, connector 120 comprises a spring 130 that constantly draws a section of foot 110 towards pin 124.

In other words, the free extremity of foot 110, employed for turning perforation device 100, is inserted between spring 130 and pin 124, and a section of foot 110 is therefore thrust against pin 124.

So foot 110 is free to rotate.

Perforation device 100 is therefore separable from arm 10.

Having separated perforation device 100 from arm 10 and extracted adapter 40 from container 14, a further adapter 200 can be inserted into container 14 to house a plastic capsule 210, normally already perforated for the passage of boiling water (FIG. 8).

In this embodiment the housing of connector 121 on lever 12 or stem 18 can be covered by a cap 220.

According to a further form of embodiment, container 14 is moreover suitable for housing a traditional filter for ground coffee or a reduced traditional filter to accommodate a permeable sheath, generally in paper, containing ground coffee.

Innovatively, the coffee machine and the arm according to this invention also permit the use of sealed capsules with manual machines.

Advantageously, the machine perforates the sealed capsule effortlessly and without dangerous operations such as perforation by hand outside the machine.

According to a further advantageous aspect, capsule perforation on cap and bottom is carried out precisely and reliably.

Advantageously, moreover, the arm can also be used with non-sealed capsules, which is to say in plastic, or with loose ground coffee or with a sheath in permeable paper.

Clearly, a specialised technician could satisfy contingent requirements by carrying out modifications to the machine and arm described above.

For example, according to one variant of embodiment, the container is profiled in such a way as to accommodate the sealed capsule; in this variant no adapter is envisaged.

According to a further variant of embodiment, the perforation plate is of a piece with the outlet opening of the machine body and the arm, turning in engagement with the annular wall of the outlet opening and shifting at the same time, brings the sealed capsule against the outlet opening perforation plate.

According to yet another variant of embodiment, the perforation device is connected to the arm to shift away from the container to permit replacement of the adapter with other adapters or traditional filters, without being separated from the arm.

According to yet another form of embodiment, arm 10 comprises means of extraction suitable for thrusting the capsule, at least partially, out of the container in order to facilitate capsule extraction when the arm is separated from the machine body (figures from 9 to 13).

Preferably, the said means of extraction comprise a support base 300 housed on the bottom of container 14 (or of the adapter) and an elastic extraction element 302, for example a helicoid spring set between support base 300 and the bottom of container 14.

When capsule 30 is in container 14 it lies on extraction base 300; when the arm is engaged with the machine body, elastic extraction element 302 is under tension between extraction base 300 and the bottom of container 14.

When arm 10 is disengaged from the machine body, elastic element 302, through extraction base 300, thrusts capsule 30 at least partially out of container 14, facilitating grip and therefore extraction.

According to a favoured form of embodiment, the means of perforation comprise at least one sharp element 50b for perforating the bottom of capsule 30, an element set on the bottom of container 14, projecting from the extraction base 300 and, for example, coaxial with the elastic extraction element 302.

Advantageously, the means of extraction are especially useful inasmuch as they facilitate extraction of the used capsule, without the need to bang the arm against a fixed point to get the capsule out of the container and without bothersome attempts to extract the capsule manually.

The means of extraction are particularly useful in the case of sealed capsules since the forces in play for perforation thrust the capsule firmly into the container.

According to a variant of embodiment, the means of perforation comprise base body 360 comprising a discoid housing body 362 and foot 110, hinged with rotation axis Z to lever 12.

Housing body 362, in the closure configuration, surmounts the chamber in container 14; in the part facing the inside of container 14, housing body 362 has a housing chamber.

Housing body 362 comprises at least one through conduit 364 which, when the arm is engaged with the machine body, puts outlet opening 1 of the machine body into fluidic communication with the chamber inside container 14.

For example, housing body 362 has a through hole housing a screw 368 equipped with an internal conduit.

The base body 360 moreover comprises a ring seal 370, housed peripherally to the housing chamber of housing body 362, and a perforation plate 372 housed in the housing chamber, concentrically to the ring seal.

Perforation plate 372 moreover comprises perforating projections 374 for perforating the cap of the capsule.

Screw 368 fixes perforation plate 372 in the chamber of housing body 362 and crosses it in such a way as to create a conduit of fluidic communication between outlet opening 1 and container chamber 14.

Preferably, the perforation plate 372 is perforated.

Preferably, in the variant described, base body 360 is fixed to lever 12, which is to say is inseparable from it.

Preferably, arm 10 comprises a spout 400 to channel the beverage produced.

These variants are also contained within the context of safeguarding as defined by the following claims.

1. Coffee holding arm for a hand loading electric coffee machine comprising:
a lever (12) for the grip, extending along lever axis (Y);
a container (14) at the extremity of the lever (12) suitable for housing a sealed capsule (30);
a perforation device comprising a base body (360) comprising a housing body (362) which, in the closure configuration, surmounts the chamber within the container (14) above the capsule (30), in which the base body (360), thrust towards the container, is such as to cause perforation of the capsule;
means of extraction suitable for thrusting the capsule at least partially out of the container, to facilitate extraction of the capsule when the arm is separated from the machine.

2. Arm according to claim 1 in which said means of extraction comprise a support base (300) housed on the bottom of the container (14) and an elastic extraction element (302), for example a helicoid spring, set in compression between the support base (300) and the bottom of container (14).

3. Arm according to claim 1 comprising least one sharp element (50, 50b) on which to set the capsule that it may be perforated on the bottom.

4. Arm according to claim 3 in which the sharp element (50b) for perforating the bottom of the capsule (30) is set on the bottom of the container (14), projecting from the extraction base (300) and, for example, coaxial with the elastic extraction element (302).

5. Arm according to claim 1 in which the base body (360) comprises at least one projection (374) for perforation of the capsule cap (30).

6. Arm according to claim 1 in which the perforation device comprises a foot (110) connected to the housing body (362) and hinged externally to the container in order to rotate and bring the housing body towards or away from the container opening (14).

7. Arm according to claim 1 in which the base body (360) comprises a perforation plate (372) set in the housing body (362) and at least one screw (368) which fixes the perforation plate (372) to the housing body (362), the said screw having an internal through hole that passes by way of the housing body and the perforation plate.

8. Hand loading electric coffee machine comprising:
an outlet opening (1) into which a boiling water feed conduit discharges (2), comprising an annular wall (6) and a detent element (11);
a coffee holding arm (10) created according to claim 1.
